(19) United States
(12) Patent Application Publication
(10) Pub. No.: US 2002/0198716 A1
(43) Pub. Date: Dec. 26, 2002

(54) System and method of improved communication

(76) Inventor: Kurt Zimmerman, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/891,030

(22) Filed: Jun. 25, 2001

(51) Int. Cl. G10L 21/00

(52) U.S. Cl. 704/270

(57) ABSTRACT

A communication system and improved method of communication using communication devices are provided. The system is preferably conducted over Internet, wireless, or similar networks. The communication system involves exchanging words, text, and static or moving pictures. The system includes a voice recognition system, a database of text and symbols, a translation system, and transmission system.

### BACKGROUND OF THE INVENTION

1. Field of the Invention

The present invention relates to an interactive method of communication, and, in particular, communication on video equipment involving exchanging words, text, and/or static or moving pictures.

2. Description of the Related Art

As the Internet and the wireless phone become more pervasive, the opportunity to entertain and better communicate becomes all the more viable. The current method for interactively communicating via video equipment, such as on the Internet or via wireless phone, either involves exchanging words (voice), text or sometimes, static pictures via e-mail, attachments or links. While the current methods effectively communicate a message, they are often lacking in communicative and entertainment value.

Videophones and wireless games have recently become more popular. However, they do not permit communication between multiple users wherein text or voice messages are converted into static or moving pictures, or animations.

In today's phone and Internet telecommunications, the communication process is bound by substantial and unnecessary constraints. The constraints often prevent us from being able to fully understand and remember what is being communicated. Most communication today is aimed at exchanging ideas and acquiring a common understanding of the topics discussed. In traditional communication between two or more participants, the feedback provided regarding the dialog comes from either a language biased response to something one participant has said, or comes by hearing something one participant has said, or comes by hearing or reading the words being exchanged. In many conversations, the communicators do not even know exactly what was communicated until afterward because they don't typically examine in detail what is being expressed. Traditional communication over the phone or Internet requires the abstraction of language (words) to images or pictures, to fully understand and appreciate the content.

There is a need for a system to improve communication by communicating symbolically using images or pictures in addition to traditional methods of communication.

### SUMMARY OF THE INVENTION

The present invention is an improved system and method of communication using images or pictures in addition to traditional methods of communication. The system receives input data in the form of an audio stream (voice) or text and converts the audio or text into a corresponding symbolic image. The image conveys the ideas being communicated in speech or writing in a meaningful, illustrative, humorous, and pleasurable manner for improved communication and entertainment.

In a preferred embodiment, the conversion of audio or text into image takes place on the network. When one participant says “Hello”, “Hello” is heard and a short animated image of a person bowing and tipping their hat is presented to both participants. The image is retrieved from a database located at the server of the network provider. The visual feedback is experienced by both participants.

In an alternative embodiment, the conversion occurs at the communication device. Similarly, when one participant says “Hello”, “Hello” is heard and a short animated image of a person bowing and tipping their hat is presented to the sending and receiving end-user. However, in this embodiment, the image is retrieved from a database located at the communication device. Preferably, both the sender and receiver see the image feedback at their communication device.

In an alternative embodiment, the system is stand alone, and conversion occurs at the communication device. When the participant says “Hello”, “Hello” is heard and a short animated image of a person bowing and tipping their hat is presented to the same participant. The image is retrieved from a look-up table located at the communication device or from a database located at a server connected to the network.

The system preferably includes a communication device, which may be a wireless telephone, hand-held computer, personal computer, or the like. The communication system may comprise one communication device or a plurality of communication devices connected over a network.

The system preferably comprises a voice recognition system for converting voice input data into text or words. The voice data is received at a receiver, preferably in the communication device. However, the receiver may also be located within the network remote from the communication device. The voice recognition system preferably comprises an acoustic processor, a word decoder, a transmitter and receiver for processing voice data and converting it into text, which may be used with the database.

The system may also include a database server, which comprises a database of words, images, and animations. The server converts the input voice or text data into a corresponding image or animation using the information contained within the database. The associated images are transmitted to a communication device, which are displayed on a visual display screen at the communication device. Alternatively, the database is located at the memory of the communication device.

The system may alternatively receive the input data in the form of images or text. Conversion of images to text or text to images may be performed. The voice recognition system and server may be located at the communications device or within the network.

The present invention also comprises a method of improved communication, including interfacing a communications device with a network. The system receives the voice or text input data from the communications device and converts the input data into output data, in the form of an image. The images may be static or moving pictures, or animations. The image may be converted and subsequently transmitted to a communication device from the server. Alternatively, the voice or text data may be transmitted to a communication device, where it is converted into an image. In one embodiment, the receiving, converting, translating, and transmitting are implemented on the network. In an alternative embodiment, the receiving, converting, and translating are implemented in the communications device. The information is preferably transmitted on the network, and the image is displayed on the end user's communication device.

The end user may also communicate in response to the initial communication using the same system and method.

### BRIEF DESCRIPTION OF THE DRAWINGS

FIG. 1 is a schematic diagram of a network configuration of the present invention.

FIG. 2 is a schematic diagram of an embodiment of the present invention having a remote system configuration.

FIG. 3 is a schematic diagram of an embodiment of the present invention having an end device configuration.

FIG. 4 is a schematic diagram of an embodiment of the present invention having a stand-alone configuration.

FIG. 5 is a block diagram of a traditional speech recognition system.

FIG. 6 is a block diagram of an exemplary implementation of the present invention in a wireless communication environment.

FIG. 7 is a block diagram of an alternative traditional speech recognition system.

FIG. 8 is a diagram of a database of the present invention.

### DETAILED DESCRIPTION OF THE PREFERRED EMBODIMENT

The following detailed description of certain embodiments presents various descriptions of specific embodiments of the present invention. However, the present invention can be embodied in a multitude of different ways as defined and covered by the claims. In this description, reference is made to the drawings wherein like parts are designated with like numerals throughout.

Technical Terms

The following provides a number of useful possible definitions of terms used in describing certain embodiments of the disclosed invention. In general, a broad definition of a term is intended when alternative meanings exist.

A network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency multiple access (FDMA), among others.

A computer or computing device may be any processor controlled device that permits access to a network, including terminal devices, such as personal computers, workstations, servers, clients, mini-computers, main-frame computers, laptop computers, mobile computers, palm-top computers, hand-held computers, set top boxes for a television, other types of web-enabled televisions, interactive kiosks, personal digital assistants, interactive or web-enabled wireless communications devices, mobile web browsers, pagers, cellular phones, or a combination thereof. A computer may possess one or more input devices such as a keyboard, mouse, touch-pad, joystick, pen-input-pad, microphone, or other input device. A computer may also include an output device, such as a visual display and an audio output. One or more of these computing devices may form a computing environment.

A computer may be a uni-processor or multi-processor machine. Additionally, a computer may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other devices to transmit or store electronic content such as, by way of example, programs and data. In one embodiment, the computers are equipped with a network communication device such as a network interface card, a modem, or other network connection device suitable for connecting to the communication network. Furthermore, a computer may execute an appropriate operating system such as Linux, Unix, any of the versions of Microsoft Windows, Apple MacOS, IBM OS/2, or other operating systems. The appropriate operating system may include a communications protocol implementation that handles all incoming and outgoing message traffic passed over the network.

A computer may contain a program or logic, which causes the computer to operate in a specific and predefined manner, as described herein. In one embodiment, the program or logic may be implemented as one or more object frameworks or modules. These modules may be configured to reside on the addressable storage medium, and configured to execute on one or more processors. The modules include, but are not limited to, software or hardware components that perform certain tasks. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided in the components, modules, and databases may be combined into fewer components, modules, or databases or further separated into additional components, modules or databases. Additionally, the components, modules, and databases may be implemented to execute on one or more computers.

Verbal communication represents any form of communication involving spoken words. A word includes a meaningful sound or combination of sounds that is a unit of language or its representation in text. Verbal communication may also include groups of words. Word, as defined in the present invention, excludes programming words.

Description of the Invention

A system and method for improved communication and entertainment are provided through interactive communication via motion picture or still frame picture scenarios presented at a communication device's video display. Using the present invention, a person forms a message in text or voice. This message may be decomposed into elements on which a server operates. The text or voice message is converted into a symbolic image, short motion picture scenario, or animation sequence stored within the server. When a completed sequence of images is ready to send, the server or communication device transmits the symbolic image, motion picture scenario or animation to the participant(s) interacting in the conversation. The receiving user receives data in the form of a symbolic image, short motion picture, or animation on the communication device sometimes in addition to the voice or text message.

The present invention automatically identifies, interprets, and displays an image to a participant in a conversation, showing the symbolic or pictorial meaning of the word(s) expressed within the conversation. A participant sees the image, and sometimes hears the words another participant is communicating in image or picture form and sometimes in text or voice form via a communications interface display device. With both words and images to leverage in the communications process, the ability for the end users to reflect, communicate and develop a common understanding of that which is being discussed is greatly increased. Using the present invention, as a series of words are expressed over communications facilities between participants, a series of corresponding images (pictures/symbols) are also preferably being displayed contemporaneously and in sequence with the words.

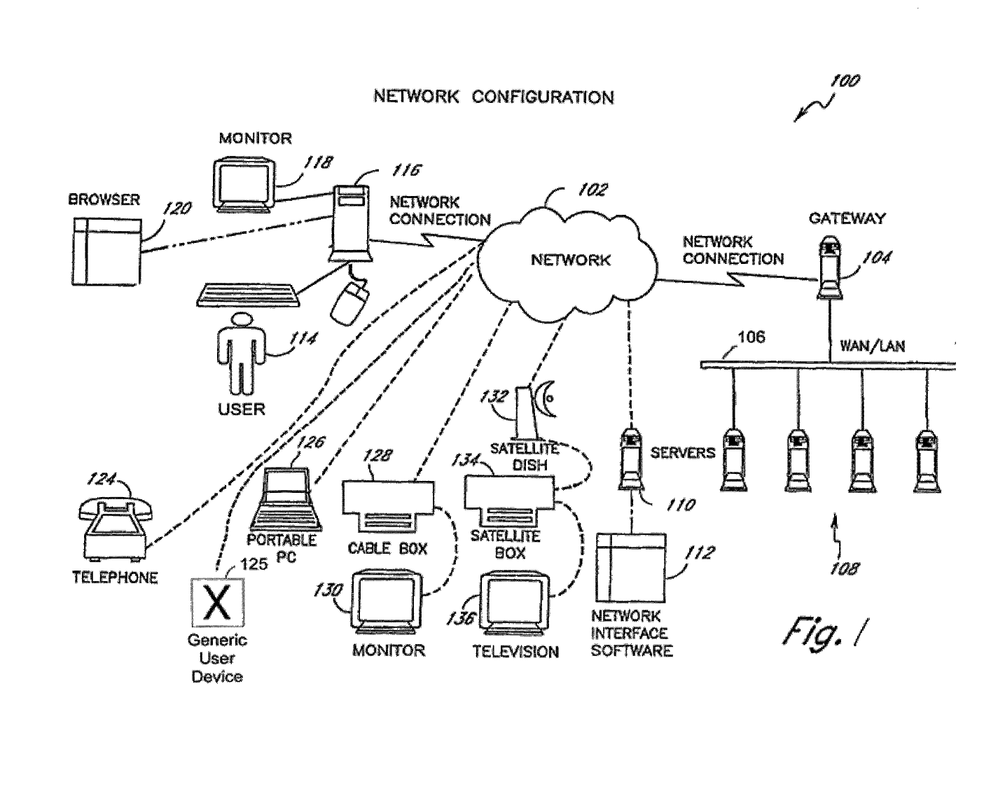

FIG. 1 is a diagram of one example of a network configuration 100 in which an improved communication system may operate. However, various other types of electronic devices communicating in a networked environment may also be used. In this example, a user 114 communicates with a computing environment, which may include multiple server computers 108 or a single server computer 110 in a client/server relationship on a network transmission medium 102. The user 114 may include a plurality of types of users, for example an end user, an author, an administrator, or other user that may be accessing the computing environment for a variety of reasons. In a typical client/server environment, each of the server computers 108, 110 may include a server program that communicates with a user device 116, which may be a personal computer (PC), a hand-held electronic device (such as a PDA), a mobile or cellular wireless phone, a laptop computer, a TV set, a radio or any number of other devices.

The server computers 108, 110 and the user device 116 may each include a network terminal equipped with a video display 118, keyboard and pointing device. In one embodiment of the network configuration 100, the user device 116 includes a network browser 120 used to access the server computers 108, 110. The network browser 120 may be, for example, Microsoft Internet Explorer or Netscape Navigator. The user 114 at the user device 116 may utilize the browser 120 to remotely access the server program using a keyboard and/or pointing device and a visual display, such as the monitor 118. Although FIG. 1 shows only one user device 116, the network configuration 100 may include any number and type of user devices.

The user device 116 may connect to the network 102 by use of a modem or by use of a network interface card that resides in the user device 116. The server computers 108 may be connected via a local area network 106 to a network gateway 104, which provides access to the local area network 106 via a high-speed, dedicated data circuit.

As would be understood by one skilled in the technology, devices other than the hardware configurations described above may be used to communicate with the server computers 108, 110. If the server computers 108, 110 are equipped with voice recognition or Dual Tone Multi-Frequency hardware, the user 114 may communicate with the server computers by use of a telephonic device 124. The telephonic device 124 may optionally be quipped with a display screen 118 and a browser 120. Other examples of connection devices for communicating with the server computers 108, 110 include a portable personal computer (PC) 126 or a personal digital assistant (PDA) device with a modem or wireless connection interface, a cable interface device 128 connected to a visual display 130, or a satellite dish 132 connected to a satellite receiver 134 and a television 136. Still other methods of allowing communication between the user 114 and the server computers 108, 110 are additionally within the scope of the invention and are shown in FIG. 1 as a generic user device 125. The generic user device 125 may be any of the computing or communication devices listed above, or any other similar device allowing a user to communicate with another device over a network. The servers 110 may also include network interface software 112.

Additionally, the server computers 108, 110 and the user device 116 may be located in different rooms, buildings or complexes. Moreover, the server computers 108, 110 and the user device 116 could be located in different geographical locations, for example in different cities, states or countries. This geographical flexibility which networked communications allows is within the scope of the invention.

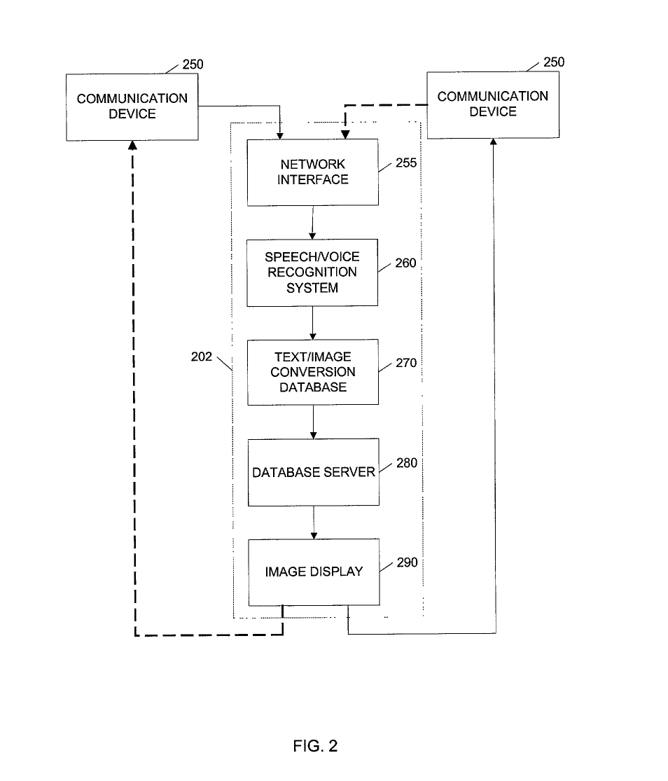

The present invention may be provided using different methods of delivery. A common voice/text recognition and image server component 202 resident within the wireless, wireline, or Internet communications network may be used, as shown in FIG. 2. Using the common server configuration, the network provider of communications services would station the required apparatus within the common network thus allowing all participants to access the same images from a common source. The common server configuration would generally include audio and video display device capability as opposed to end-computing capability at the end-users device. In this embodiment, implementing the example given previously, when one participant says “Hello”, “Hello” is heard and a short animated image of a person bowing and tipping their hat is presented to both participants. The image is retrieved from a database located at the server of the network provider. The visual feedback is experienced by both participants.

In this embodiment, the network interface is preferably connected to the wireless, wireline, Internet network, or the like, depending on the particular communication devices used. The communication devices 250 correspond with the devices 124, 125, 126, 128 and 132 of FIG. 1, for example. The network interface 255 receives and transmits the voice, text, and/or video data streams to and from the communications devices 250. The system also preferably includes a voice recognition system 260 for converting voice data into text. In embodiments wherein the data is initially received in text, no voice recognition is required and the data goes directly to the text-to-image conversion database 270 located in the database server 280. The database 270 preferably includes a look-up table including a list of words and associated symbols or animations associated with those words. Alternatively, the database 270 may include a direct voice to image conversion database. The image is sent from the image database server 280, which transmits the image to the receiving communication device 250. The images may be in the form of animations, or moving or still frame pictures. The image is displayed on the end users communication device display screen. The image display 290 may display images and text that are being sent and/or received. In the present embodiment, the network interface 255, voice recognition system 260, database 270 and server 280 are preferably located within the common network server 202.

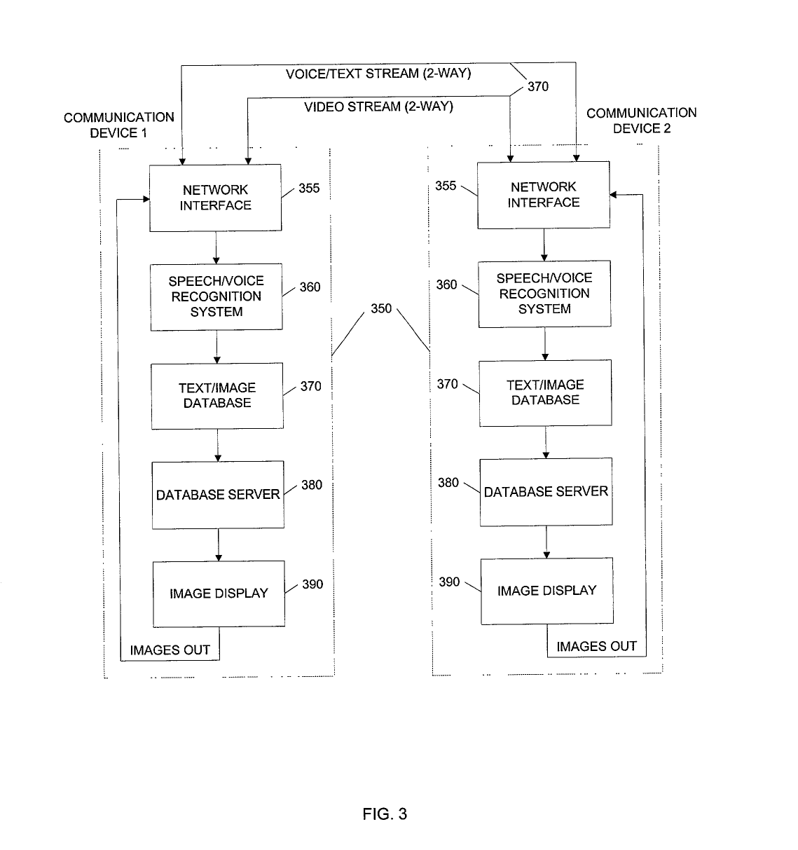

In an alternative embodiment, the system may be implemented through voice recognition and image serving components within the end user's end-computing communications device (FIG. 3). In this embodiment, the common communications network remains unmodified and traditional, while the services are provided at the end user's level. The end user's communication device recognizes the language component elements, and then matches the language with images presenting the images in real-time to a receiving end user. When one participant says “Hello”, “Hello” is heard and a short animation of a person bowing and tipping their hat is presented to the receiving end-user. The image may be retrieved from a database located at the receiving end-user's communication device. Alternatively, the sender's device matches the language components with the images, which are sent to the receiving end user over the network. Thus, the image of a person bowing and tipping their hat may be displayed at both user's communication devices.

FIG. 3 shows a schematic diagram of the embodiment wherein the components are implemented within the end user's devices. The audio or text data is sent over the network 102 (FIG. 1) and manipulated, interpreted, and converted at the end-user's communication devices 350. The communication devices 350 may include any computer or computing device, as previously described with reference to FIG. 1. Alternatively, the audio or text data is manipulated, interpreted, and converted at the transmitting device and then sent as image data over the network. The network interfaces 355 are preferably capable of transmitting and receiving audio, text, and video data. The system also preferably includes voice recognition systems 360 located within the communication devices 350, for converting audio data into text. The text is manipulated and converted into an image at databases 370 contained within database servers 380 located within the communication devices 350. The databases 370 include text and associated static or moving pictures, or animations. The text and video data may be displayed on display screens 390 at the communication devices 350.

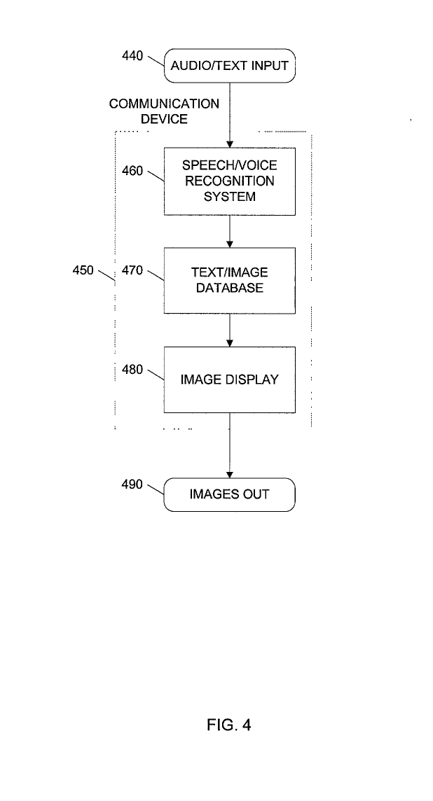

In an alternative embodiment, the entire system may be located within a single communication device 450. FIG. 4 shows a schematic diagram of the present embodiment, wherein communication device 450 stands alone. The communication device 450 corresponds with the computer and computing devices as previously described with reference to FIG. 1, such as devices 124, 125, 126, 128, and 132, for example. The communication device 450 of the present embodiment comprises a voice recognition system 460, for converting audio data into text. The text may be manipulated and converted into an image at a look-up table 470 within the communication device 450. The look-up table 470 is preferably stored in the memory at the communication device 450. Alternatively, a database and database server may be located within a communications network (not shown). The communication device 450 may include an Internet connection for connecting to a communications network having a database of images. The database allows for conversion of the voice and/or text data into associated images in the form of static or moving pictures, or animations. The text and video data 490 are preferably displayed on a display screen 480 at the communication device.

The personal communication devices may be connected over a network, as previously discussed.

The voice recognition systems 260, 360, and 460 may be as described in U.S. Pat. No. 5,956,683, which is incorporated by reference herein. A voice recognition system typically employs techniques to recover a linguistic message from an acoustic speech signal, using voice recognizers. A voice recognizer preferably comprises an acoustic processor which extracts a sequence of information-bearing features (vectors) necessary for voice recognition from the incoming raw speech, and a word decoder, which decodes the sequence of features (vectors) to yield the meaningful and desired formation of output, such as a sequence of linguistic words corresponding to the input utterance.

The acoustic processor or feature extraction element preferably resides in the personal communication device and the word decoder resides in the central communications center. The acoustic process may reside at the central communications center; however, using current technology, the accuracy is dramatically decreased.

The acoustic processor represents a front end speech analysis subsystem. In response to an input speech signal, it provides an appropriate representation to characterize the time-varying speech signal. It preferably discards irrelevant information such as background noise, channel distortion, speaker characteristics and manner of speaking.

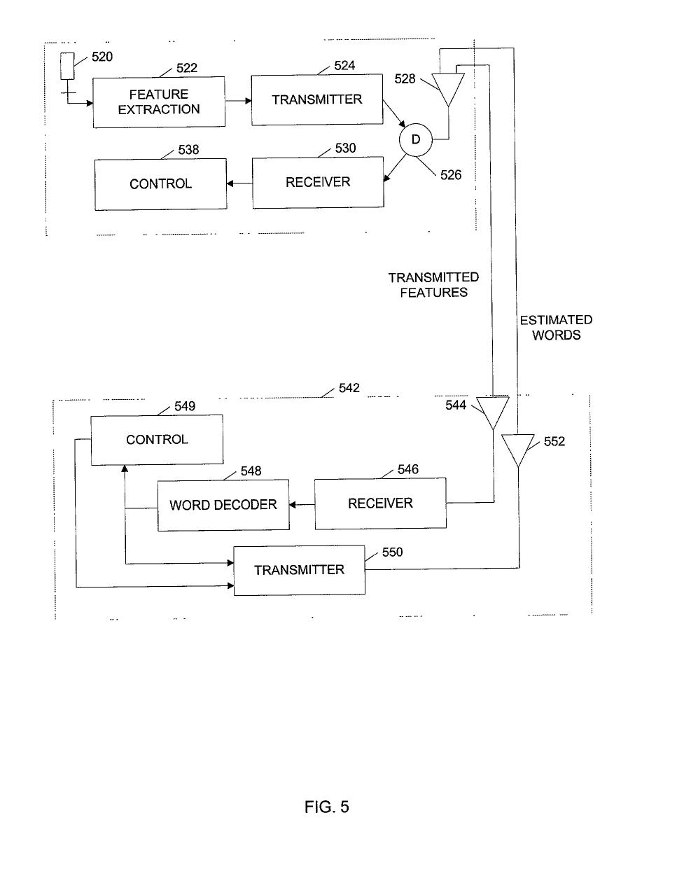

Referring to FIG. 5, the input speech is preferably provided to a microphone 520 which converts the speech signal into electrical signals which are provided to a feature extraction element 522. The microphone 520 is preferably located at the communication device. The signals from the microphone may be analog or digital. If the signals are analog, an analog to digital converter may be provided to convert the signals. The feature extraction element 522 extracts relevant characteristics of the input speech that will be used to decode the linguistic interpretation of the input speech. The extracted features of the speech are then provided to a transmitter 524 which codes, modulates and amplifies the extracted feature signal and provides the features through a duplexer 526 to an antenna 528, where the speech features are transmitted to a cellular base station or central communications center 542. Various types of digital coding, modulation, and transmission schemes known in the art may be employed.

At a central communications center 542, the transmitted features are received at an antenna 544 and provided to a receiver 546. The receiver may perform the functions of modulating and decoding of the received transmitted data which it in turn provides to a word decoder 548.

A word decoder 548 is preferably provided to translate the acoustic feature sequence produced by the acoustic processor into an estimate of the speaker's original word string. This is preferably accomplished with acoustic pattern matching and language modeling. Language modeling may be avoided in applications of isolated word recognition. The parameters from an analysis element are provided to an acoustic pattern matching element to detect and classify possible acoustic patterns, such as phonemes, syllables, words, etc. The candidate patterns are provided to a language modeling element, which models the rules of syntactic constraints that determine what sequences of words are grammatically well formed and meaningful. Syntactic information can be a valuable guide to voice recognition when acoustic information alone is ambiguous. Based on language modeling, the voice recognizer may sequentially interpret the acoustic feature, match results and provide the estimated word string.

Word decoder 548 provides an action signal to transmitter 550, which performs the functions of amplification, modulation and coding of the action signal, and provides the amplified signal to antenna 552, which may transmit the word string to the database server. Alternatively, the action signal may be sent to control element 549 and then sent to transmitter 550.

At the receiving communication device, the estimated words or images are received at an antenna 528, which provides the received signal through a duplexer 526 to a receiver 530 which demodulates, decodes the signal and then provides the command signal or estimated words to a control element 538. The control element 538 provides the intended response, providing the information to the display screen of the communication device.

It is desirable for the word decoding system to be located at a subsystem which can absorb the computational load appropriately. The acoustic processor preferably resides as close to the speech source as possible to reduce the effects of quantization errors introduced by signal processing and/or channel induced errors.

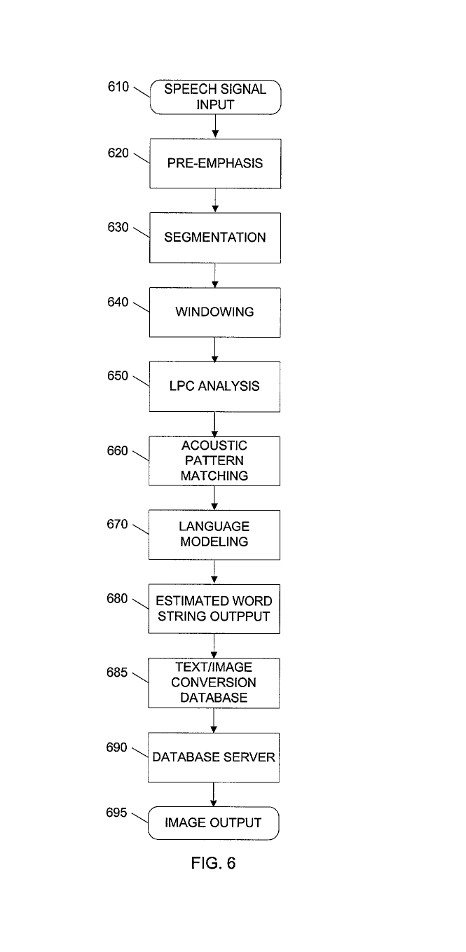

Referring to FIG. 6, an alternative voice recognition system is shown. In a linear predictive coding (LPC) processor, the input 610 is provided to a microphone (not shown) and converted to an analog electrical signal. This electrical signal may be digitized by an A/D converter (not shown). The digitized speech signals are passed through preemphasis filter 620 in order to spectrally flatten the signal and to make it less susceptible to finite precision effects in subsequent signal processing. The preemphasis filtered speech is then provided to segmentation element 630 where it is segmented or blocked into either temporally overlapped or nonoverlapped blocks. The frames of speech data are then provided to windowing element 640 where framed DC components are removed and a digital windowing operation is performed on each frame to lessen the blocking effects due to the discontinuity at frame boundaries. The windowed speech is provided to LPC analysis element 650. The LPC parameters from LPC analysis element 650 are provided to acoustic pattern matching element 660 to detect and classify possible acoustic patterns, such as phonemes, syllables, words, etc. The candidate patterns are provided to language modeling element 670, which models the rules of syntactic constraints that determine what sequences of words are grammatically well formed and meaningful. Based on language modeling, the voice recognition system, sequentially interprets the acoustic feature, matches the results and provides the estimated word string 680.

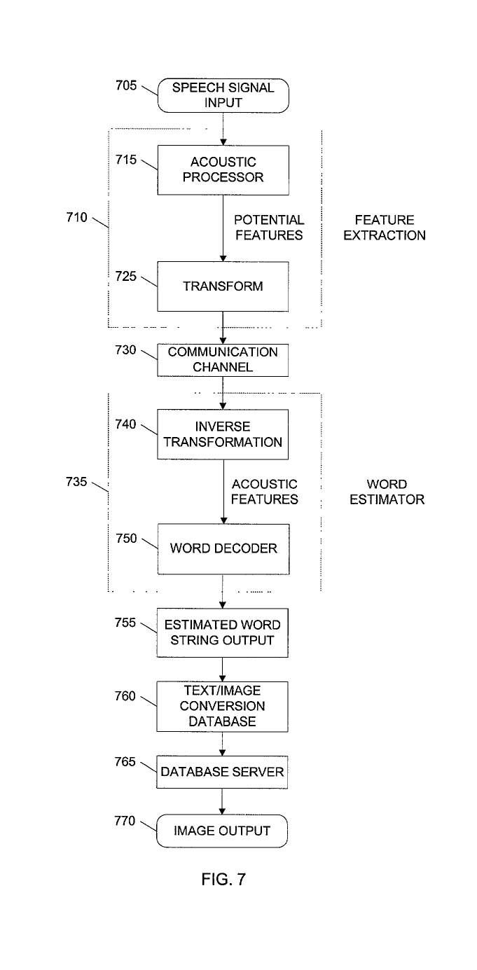

FIG. 7 shows an alternative embodiment of voice recognition systems 260, 360, 460. Input speech 705 is provided to feature extraction element 710, which provides the features over communication channel 730 to word estimation element 735 where an estimated word string is determined. The speech signals 705 are provided to acoustic processor 715 which determines potential features for each speech frame. LPCs are transformed into line spectrum pairs (LSPs) by transform element 725, which are then encoded to traverse element the communication channel 730. The transformed potential features are inverse transformed by inverse transform element 740 to provide acoustic features to word decoder 750 which in response provides an estimated word string 755.

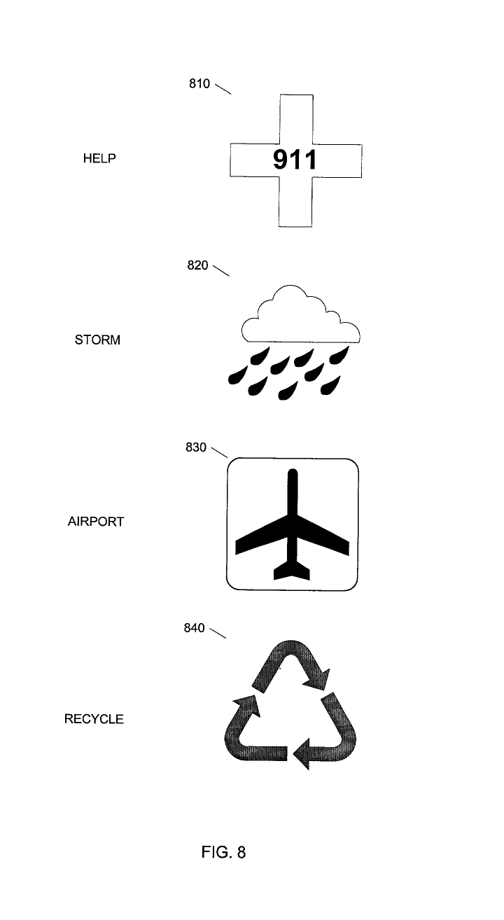

The word string, from the voice recognition systems as described with reference to FIGS. 5, 6, and 7, is preferably sent to a database 685, 760 which may be located at a database server 690, 765 or at the communication device. The database 685, 760 comprises a look-up table of words and images for matching words or groups of words with an appropriate pictorial symbol, which can be transmitted between the communications devices. The words are identified via voice or text recognition. An image 770, 695 is then associated, retrieved, and subsequently presented in accordance with the voice or text data. In embodiments, wherein words or sentences are used, it may be challenging to associate an image that exactly expresses the meaning of the language used. A common symbol may be retrieved and displayed to show meaning in many situations. Thus, if a user says “Stop”, the dictionary presents an image of a stop sign to convey the meaning. Alternatively, a still-frame of a police officer with his hand out, indicating “stop”, may be displayed. Symbols for proper names may be stored within the end users device, such that when the name “Jim” is said, a picture of “Jim” will appear on the screen. The picture of “Jim” may also be stored on the network in network-based embodiments. Alternatively, “Jim” may be simply spelled and displayed on the screen to assist with understanding and clarification. The present invention thus supplements language communication with corresponding world images. FIG. 8 shows an example of a look-up table associated with the present invention, showing some exemplary words and associated symbols. A wide array of animations and associated symbols or icons may be available to the participant to facilitate better communication. For example, when a participant says “Help”, an image of a cross containing “911” 810 is presented the participant(s). Image 820 is a cloud and raindrops, which may be used to symbolize a storm. An image of an airplane 830 may be used to symbolize “airport”. Symbol 840 is commonly known as “recycle”.

The present invention may also include a syntax module and phrase correlator. The syntax module recognizes that a word may have different meanings depending on the context of the conversation. For example, “later” may be used in response to “Goodbye”, or “later” may be used in response to “When can we talk?”. The syntax module distinguishes the meaning of the word, based on the context of the conversation. The phrase correlator relates phrases which have similar meanings. There are many ways in which people say “Hello”, such as “Hi”, “Hi there”, “Good morning”, and “Aloha”. Thus, there are many words or phrases that mean essentially the same thing. The phrase correlator matches phrases or words that have a common meaning with a common image or symbol.

Method

The composer of a message preferably types or says “Hello”. The server interprets the text or voice signal and automatically associates the message with a short animation showing a symbolic interpretation, indicating “Hello”. For example, when the composer types or says “Hello”, an image of a person bowing and taking off their hat or a waving hand may be selected to indicate “Hello”. The animation or image may be sent immediately or may be sent as a string of animations at the end of a sentence or message. Text may also be sent if pictures or animations are not available to adequately describe the message.

The receiver may also respond to the message, by composing an animated response. Alternatively, if the participant composing the message does not have another participant receiving the message, the message may be sent to a game server, which will interpret the message and reply with a differentially respondent animated response. Thus, the server would send an animated message to the original composer. The server may also initiate a provocative message in the form of an animation to entertain while conversing.

The pictures, animations, or symbols form part of the communication, such that the users may be entertained as well as enhancing communication. The present invention also offers the ability to improve communication between the language challenged, such as users speaking different languages, the young, old, hearing impaired, and the like. The present invention also allows for improved communication between those who are not language challenged. Participants are able to see the content they are expressing by providing images in addition to language, reinforcing the communications. The images add a sense of realism apart from the word as an abstraction.

Preferably, an international common language of symbols and animations may be developed, allowing all users to improve communication internationally. For example, when participants communicate using different languages, a common symbol may be used to convey words having the same meaning in the different languages. The image that “bicycle” conveys in English has the same image as “zweirad” conveys in German. The system may be used to assist in learning a foreign language. Users of the device associate word or phrase meanings by viewing the images associated with the words.

The present invention may also be used with voice mail systems. The user receives pictorial feedback in addition to the voice feedback using a telephone or wireless telephone having an image display screen.

The system may also be used while reading. When using a personal computer, the user may drag the cursor across the text, which is analyzed by the present invention to enhance understanding and entertainment. The present invention may be used with e-mail or instant messaging, wherein images are associated with the text within the e-mail message.

The present invention may be used to practice oral presentations. A stand-alone version allows the participant to practice making a presentation while receiving visual feedback as reinforcement. Similarly, the device may also be used to improve an individual's speech. The participant speaks and analyses the corresponding pictorial representation of the words. The user can adjust their speech to maximize the pictorial value of the communication.

The present invention may also be used with radios. The audio from the radio may be used as the input data into the communication system. The system then interprets the audio, supplementing the voice and music with corresponding images.

The system may also be used such that the data is not transferred in real-time. The input data may be used to generate a sequence of images which is stored on the network or at the communication device. The sequence of images allows one to create story boards capable of education and entertainment.

Although the present invention has been described in terms of certain preferred embodiments, other embodiments of the invention including variations in dimensions, configuration and materials will be apparent to those of skill in the art in view of the disclosure herein. In addition, all features discussed in connection with any one embodiment herein can be readily adapted for use in other embodiments herein. The use of different terms or reference numerals for similar features in different embodiments does not imply differences other than those which may be expressly set forth. Accordingly, the present invention is intended to be described solely by reference to the appended claims, and not limited to the preferred embodiments disclosed herein.

What is claimed is:

1. A communication system, comprising:
a speech input responsive to verbal communication;
a speech recognition processor responsive to said speech input and creating an electronic output representing said verbal communication;
a database storing words and non-textual graphic image designators corresponding to said words;
a processor responsive to said electronic output representing said verbal communication to access a graphic image designator from said database which represents said verbal communication; and
a graphic image generator responsive to said graphic image designator to generate a graphic image which represents said verbal communication.

2. The communication system of claim 1, further comprising at least one computing device which includes said speech recognition processor.

3. The communication system of claim 2, wherein said computing device is selected from the group consisting of personal computers, workstations, servers, clients, mini-computers, main-frame computers, laptop computers, mobile computers, palm-top computers, hand-held computers, set top boxes for a television, web-enabled televisions, interactive kiosks, personal digital assistants, interactive wireless communications devices, web-enabled wireless communications devices, mobile web browsers, pagers and cellular phones.

4. The communication system of claim 2, wherein said computing device comprises a display screen for displaying said graphic image.

5. The communication system of claim 2, wherein said at least one communication device accesses a network.

6. The communication system of claim 1, wherein said speech recognition processor comprises an acoustic processor and a word decoder.

7. The communication system of claim 1, wherein said graphic image is selected from the group consisting of static pictures, moving pictures, and animations.

8. The communication system of claim 1, wherein said speech recognition processor comprises a syntax module.

9. The communication system of claim 1, wherein said speech recognition processor comprises a phrase correlator.

10. A process for communicating, comprising:
inputting verbal communication to a processor;
matching, in said processor, said verbal communication with graphic, non-textual images representing said verbal communication; and
outputting from said processor said graphic images.

11. The process of claim 10, further comprising transmitting said graphic images to a display screen.

12. The process of claim 10, further comprising responding to said graphic images by inputting additional verbal communication.

13. The process of claim 10, wherein said step of inputting verbal communication comprises speaking.

14. The process of claim 12, further comprising at least two users, wherein said step of inputting verbal communication and said step of responding by inputting additional verbal communication are undertaken by different users.

15. A communication system, comprising:
a text source for generating electronic output representing words;
a database storing words and non-textual graphic image designators corresponding to said words;
a processor responsive to said electronic output representing words to access a graphic image designator from said database which represents said words; and
a graphic image generator responsive to said graphic image designator to generate a graphic image which represents said words.

16. The communication system of claim 15, further comprising at least one computing device which includes said speech recognition processor.

17. The communication system of claim 16, wherein said computing device is selected from the group consisting of personal computers, workstations, servers, clients, mini-computers, main-frame computers, laptop computers, mobile computers, palm-top computers, hand-held computers, set top boxes for a television, web-enabled televisions, interactive kiosks, personal digital assistants, interactive wireless communications devices, web-enabled wireless communications devices, mobile web browsers, pagers and cellular phones.

18. The communication system of claim 16, wherein said computing device comprises a display screen for displaying said graphic image.

19. The communication system of claim 16, wherein said at least one communication device accesses a network.

20. The communication system of claim 15, wherein said speech recognition processor comprises an acoustic processor and a word decoder.

21. The communication system of claim 15, wherein said graphic image is selected from the group consisting of static pictures, moving pictures, and animations.

22. The communication system of claim 15, wherein said speech recognition processor comprises a syntax module.

23. The communication system of claim 15, wherein said speech recognition processor comprises a phrase correlator.

24. A process for communicating, comprising:
inputting words to a processor;
matching, in said processor, said words with graphic, non-textual images representing said words; and
outputting from said processor said graphic images.

25. The process of claim 24, further comprising transmitting said graphic images to a display screen.

26. The process of claim 24, further comprising responding to said graphic images by inputting additional verbal communication.

27. The process of claim 25, wherein said step of inputting verbal communication comprises speaking.

28. The process of claim 25, further comprising at least two users, wherein said step of inputting verbal communication and said step of responding by inputting additional verbal communication are undertaken by different users.
